(19) United States
(12) Patent Application Publication
(10) Pub. No.: US 2009/0185845 A1
(43) Pub. Date: Jul. 23, 2009

(54) IMAGE FORMING APPARATUS

(75) Inventor: Yoshihiro Hata, Kodaira-shi (JP)

Correspondence Address: CANTOR COLBURN, LLP, 20 Church Street, 22nd Floor, Hartford, CT, 06103, US

(73) Assignee: Konica Minolta Business Technologies, Inc., Tokyo (JP)

(21) Appl. No.: 12/357,160

(22) Filed: Jan. 21, 2009

(30) Foreign Application Priority Data
Jan. 23, 2008 (JP) 2008-012389

(51) Int. Cl. G03G 15/00

(52) U.S. Cl. 399/367

(57) ABSTRACT

An image forming apparatus includes: a main body having; a recording sheet storing section capable of storing a recording sheet therein and being drawn from the main body, and an image forming section, which forms an image onto a recording sheet which is disposed above the recording sheet storing section, and an information storing device disposed on an upper portion of the main body, which stores at least image data.

This application is based on Japanese Patent Application No. 2008-012389 filed on Jan. 23, 2008, which is incorporated hereinto by reference.

### BACKGROUND OF THE INVENTION

The present invention relates to an image forming apparatus having therein at least an information storing device that can store and read image data.

In the field of a high speed image forming apparatus such as an image forming apparatus that forms an image through an electrophotographic process, the number of those having a hard disk drive (hereinafter referred to as HDD) is increasing for making actions of storing and reading of a large quantity of image data to be possible.

HDD is not high in terms of strength against a shock, and when the HDD is incorporated in an image forming apparatus, a measure against a shock is needed.

Only measures for shocks caused in the case of conveyance and installation of the image forming apparatus are not enough, and measures for shocks caused by an impact in use and by operations of the apparatus have been proposed.

In Unexamined Japanese Patent Application Publication No. 09-31485, there is proposed a serial printer wherein a longitudinal direction of a pickup arm of HDD is made to agree with a direction of sheet feeding.

In the image forming apparatus disclosed in Unexamined Japanese Patent Application Publication No. 09-31485, a longitudinal direction of a pickup arm of HDD is made to agree also with a scanning direction for a carriage.

In Unexamined Japanese Patent Application Publication No. 2005-88554, there is proposed an image forming apparatus wherein a direction of putting in and taking out of multi-step sheet-feeding tray is made to agree with a longitudinal direction of a pickup arm of HDD.

In proposals in Unexamined Japanese Patent Application Publication No. 09-31485 and Unexamined Japanese Patent Application Publication No. 2005-88554, though a longitudinal direction of a pickup arm of HDD is in agreement with a direction of putting in and taking out of a sheet-feeding tray, HDD is arranged to be close to sheet-feeding tray. Therefore, it is impossible to protect HDD sufficiently, against a shock caused in the case of putting in and taking out of a sheet-feeding tray, even if a longitudinal direction of a pickup arm is made to agree with a direction of putting in and taking out of sheet feeding tray.

### SUMMARY OF THE INVENTION

An aspect of the invention is as follows.

An image forming apparatus comprising; a main body having therein a recording sheet storing section that can store recording sheets and can be drawn out, and an image forming section that is arranged above the recording sheet storing section and forms an image on a recording sheet, and an information storing device that is arranged above the main body and stores at least image data.

### BRIEF DESCRIPTION OF THE DRAWINGS

Each of FIG. 1(a) and FIG. 1(b) is a side sectional view of an image forming apparatus relating to the embodiment of the invention.

FIG. 2 is a perspective vies of image forming apparatus 1 that is viewed from its upper part on the left side.

FIG. 3 is a perspective vies of image forming apparatus 1 that is viewed from its upper part on the back side.

### DETAILED DESCRIPTION OF THE PREFERRED EMBODIMENT

The invention will be explained as follows, referring to the illustrated embodiment to which, however, the invention is not limited.

Each of FIG. 1(a) and FIG. 1(b) is a side sectional view of an image forming apparatus relating to the embodiment of the invention.

Image forming apparatus 1 has main body 1A and automatic document feeder 14.

In each of FIG. 1(a) and FIG. 1(b), the left side represents front side F that is operated by an operator and the right side represents back side R.

The main body 1A has therein image reading section 10, image forming section 11 that forms an image on a recording sheet through an electrophotographic mode, sheet feeding section 12 for forming an image on the back side and sheet feeding trays 13A, 13B and 13C serving as a recording sheet storing section that stores recording sheets.

The image reading section 10, the image forming section 11 and the recording sheet storing section are arranged so that the image reading section 10 may be positioned to be highest, the image forming section 11 may be positioned to be an intermediate and the recording sheet storing section may be positioned to be lowest.

The main body 1A has an outer shape of a rectangular parallelepiped that has a foreface and a back face which are almost in parallel each other, and has the right side and the left side which are almost in parallel each other.

The image forming section 11 has therein a charging device, an exposure device, a developing device, a transfer device, a cleaning device and a fixing device, as is generally known.

Further, in the image forming section employing an intermediate transfer body, there are arranged a primary transfer device and a secondary transfer device in addition to a charging device, an exposure device, a developing device, a cleaning device and a fixing device.

On the top surface of the main body 1A, there is arranged automatic document feeder 14 that is capable of being opened and closed freely.

As is generally known, recording sheets are taken out one sheet by one sheet successively from one of sheet feeding trays 13A, 13B and 13C, and an image formed through charging, exposure and development in the image forming section is transferred onto a recording sheet.

The image thus transferred is fixed on the recording sheet by a fixing device (not shown).

In the case of one-sided image forming, a recording sheet on which an image has been formed on one side of the recording sheet is ejected to an ejection tray (not shown).

Further, in the case of two-sided image forming, a recording sheet on which an image has been formed on its obverse side is conveyed to sheet feeding section 12, and then, is reversed inside out, and an image is formed on a reverse side of the recording sheet in the image forming section, and after that, the image is fixed and ejected to the ejection tray.

An image is formed in image forming section 11 and transferred onto a recording sheet, based on image data generated through document reading by image reading section 10 or on image data received from an outer equipment.

Image data can also be stored temporarily in an information recording device described later. In this case, image data are read out from an information recording medium, in the case of image forming.

Automatic document feeder 14 is provided to be capable of rotating from the state shown in FIG. 1(a) to the state shown in FIG. 1(b) around shaft 14A on R on the back side, and the automatic document feeder 14 is set to be in the state shown in FIG. 1(a) when reading a document.

Image reading section 10 has platen glass 10a, and a document placed on the platen glass 10a and a document conveyed by the automatic document feeder 14 can be read by the image reading section 10.

When placing a document on platen glass 10a, the automatic document feeder 14 is opened as shown in FIG. 1(b).

When supplying recording sheets in image forming apparatus 1, sheet feeding trays 13A, 13B and 13C are drawn out in the direction indicated with arrow A, namely, toward front side F.

When the sheet feeding trays 13A, 13B and 13C into which recording sheets are replenished are moved in the direction indicated with arrow B that is opposite to arrow A, namely, when the sheet feeding trays 13A, 13B and 13C are pushed to back side R, they are loaded and the preparation of sheet feeding is completed.

HDD15 representing an information storing device is arranged to be at the uppermost portion of image forming apparatus 1 and to be at back side R.

HDD15 is an information storing device that stores various types of data including image data and stores programs for various types of controls. HDD15 has therein a hard disk representing a disk-shaped storing medium.

In the meanwhile, as an information storing device, it is possible to use those which employ disk-shaped storing medium and are capable of storing and reading information, such as magneto optic disk drive (MO, MD) in addition to HDD.

As illustrated, HDD15 is arranged to be further back side of automatic document feeder 14, for the automatic document feeder 14, and is arranged to be away from the automatic document feeder 14, with a certain space so that the automatic document feeder 14 may be opened and closed.

HDD15 is housed in housing 15A and is arranged longitudinally as illustrated.

The expression of “arranged longitudinally” in this case means that HDD15 is arranged so that an information storing surface of disk-shaped storing medium (hard disk) may be in parallel with rear side RS of main body 1A.

As is commonly known, HDD15 is a component whose strength for shocks is relatively low, and a hard disk and a motor bearing of HDD15 are easily damaged by shocks.

On the other hand, in image forming apparatus 1, shocks are caused when mounting and dismounting sheet feeding trays 13A, 13B and 13C, which sometimes damages HDD15.

As illustrated, HDD15 is arranged at the uppermost and backmost portion that is farthest from sheet feeding trays 13A, 13B and 13C which are arranged at a lower portion and front side F portion in image forming apparatus 1.

The farther a shock wave is from its source of occurrence, the higher the degree of its attenuation is. Further, since image forming section 11 having greater mass stands between HDD15 and the sheet feeding trays 13A, 13B and 13C, shocks caused by mounting and dismounting of the sheet feeding trays 13A, 13B and 13C are lightened by the image forming section 11.

As a result, it is prevented that HDD15 is damaged by mounting and dismounting of the sheet feeding trays 13A, 13B and 13C.

Sheet feeding tray 13C arranged at the lowermost position is formed to be larger than other sheet feeding trays 13A and 13B in terms of capacity. Namely, the number of sheets stored in the sheet feeding tray 13C is greater than that of sheets stored in any other sheet feeding tray.

Since the sheet feeding tray 13C is of the large capacity, a shock caused by mounting and dismounting of the sheet feeding tray 13C is greater than that caused by mounting and dismounting of another sheet feeding tray 13A or 13B. In other words, a possibility for HDD15 to be damaged by mounting and dismounting of the sheet feeding tray 13C is high. However, the sheet feeding tray 13C is arranged to be farther from HDD15, compared with other sheet feeding trays 13A and 13B. Therefore, a degree of lightening for shocks caused by mounting and dismounting of the sheet feeding tray 13C which is carried out in a period during which the shock is transmitted to HDD15 is high. As a result, an effect to prevent that HDD15 is damaged is exhibited especially effectively.

HDD15 is arranged behind automatic document feeder 14 to be away from it by a certain space as illustrated, and it is provided in housing 15A that is protruded from a top surface of main body 1A.

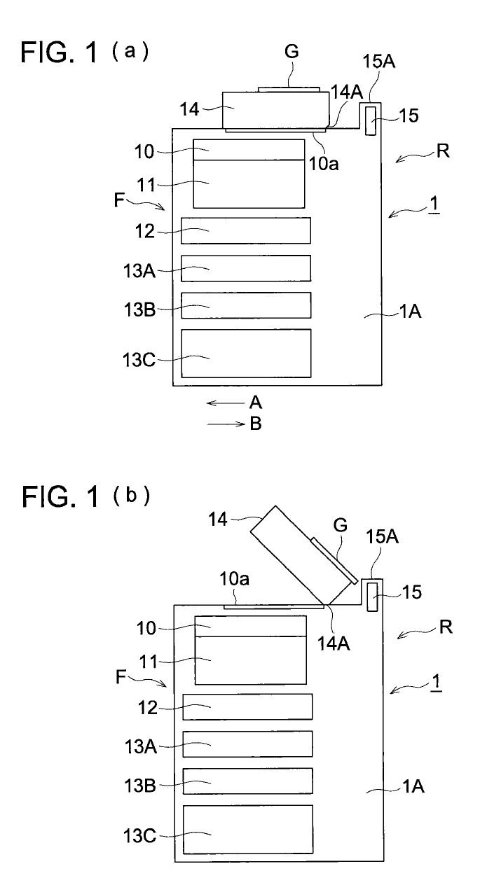

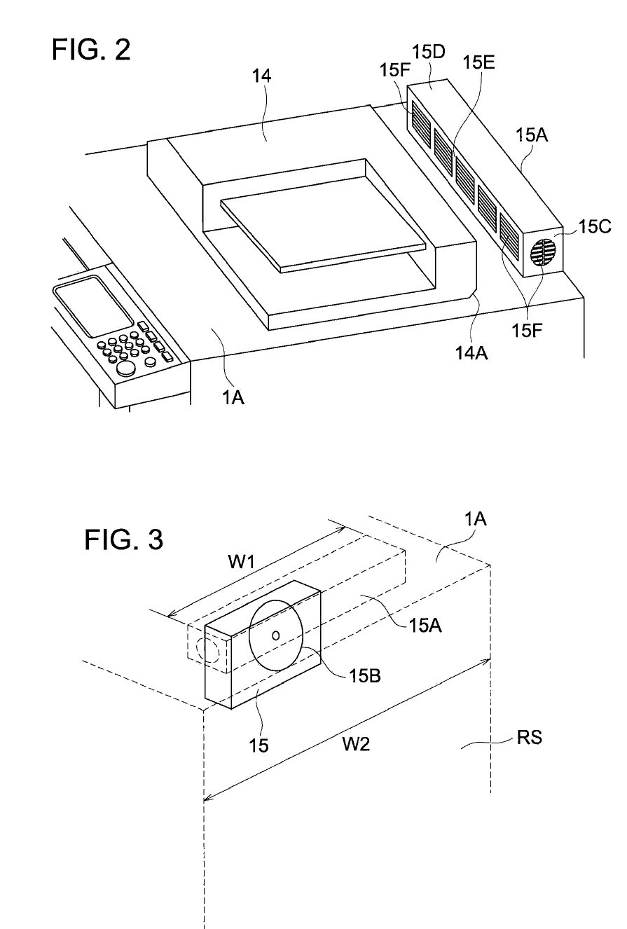

FIG. 2 is a perspective view of image forming apparatus 1 that is viewed from its upper part on the right side. FIG. 3 is a perspective view of image forming apparatus 1 that is viewed from its upper part on the back side.

Above main body 1A, there are arranged automatic document feeder 14 and HDD15 as explained earlier, and housing 15A that houses HDD15 is arranged at the back side of automatic document feeder 14 to be away from it by a certain space.

The housing 15A is protruded upward from the main body 1A, and has panels 15C, 15D and 15E.

As is shown in FIG. 1(b), when automatic document feeder 14 is opened and its top surface is inclined, document G placed on the automatic document feeder 14 sometimes slips down the automatic document feeder 14.

When the top surface of the main body 1A is flat, document G falls on the floor from the main body 1A. Namely, when the automatic document feeder 14 is opened carelessly under the condition that the document G is left on the automatic document feeder 14 as it is, there may be caused a situation that the document G falls in the reverse side of image forming apparatus 1.

By providing HDD15 at a position that is further back side R than the automatic document feeder is, even when document G falls from the automatic document feeder, the fallen document G is supported by HDD15, thus, it is possible to prevent that document G falls on the back side of image forming apparatus 1.

Though a 3.5-inch HDD has outside dimensions of about 100 mm×150 mm×20 mm, a height of protrusion of housing 15A from main body 1A can be made to be almost the same as a height of automatic document feeder 14, by arranging HDD15 longitudinally as illustrated, thus, it is possible to cause housing 15A to have functions to prevent sliding down of a document.

As is shown in FIG. 2, the housing 15A has panel 15C on an end portion, panel 15D on a top surface and panel 15E on a front surface. At least one of panels constituting the housing is removable.

By removing panels which constitute housing 15A, maintenance work for HDD15 can be carried out, easily.

Since housing 15A for HDD15 is protruded from main body 1A, workability for maintenance work is improved.

As is shown in FIG. 2, there are provided slit-shaped draft holes 15F on panels 15C and 15E. By causing the open air to pass through the draft holes 15F, a temperature rise of HDD15 is inhibited.

Further, as is shown in FIG. 3, HDD15 is arranged longitudinally so that a storing surface of hard disk 15B may be in parallel with rear side RS of main body 1A. Owing to this arrangement, a length of housing 15A in a depth direction is shortened, whereby, HDD can be arranged at the back side of automatic document feeder 14, and housing 15 can be formed to be away from the automatic document feeder 14 by a certain space. In the meanwhile, FIG. 3 is a perspective view of image forming apparatus 1 that is viewed from its upper part on the back side.

Further, a width in a left and right direction of housing 15A that houses HDD 15, namely, width W1 in a direction toward back side R from front side F in FIGS. 1(a) and 1(b) can be made smaller than width W2 in the aforesaid left and right direction of main body 1A, because HDD15 has the aforesaid outside dimensions.

Owing to the foregoing, the housing 15A can be provided without protruding from main body 1A in the aforesaid left and right direction.

In the invention, an image forming section that forms an image on a recording sheet through an electrophotographic process is caused to stand between an information storing device and a recording sheet storing section.

Owing to this, the information storing device and the recording sheet storing section are arranged in a structure with an image forming section having large mass and volume between them.

Therefore, shocks generated by mounting and dismounting operations in a recording sheet storing section are lightened by the image forming section, and a distance between the information storing device and the recording sheet storing section can be made long, thus, shock waves are attenuated.

As a result, it is possible to prevent sufficiently damages of the information storing device caused by mounting and dismounting in recording sheet storing section.

What is claimed is:

1. An image forming apparatus comprising:
(a) a main body having;
(1) a recording sheet storing section capable of storing a recording sheet therein and being drawn from the main body, and
(2) an image forming section, which forms an image onto a recording sheet which is disposed above the recording sheet storing section, and
(b) an information storing device disposed on an upper portion of the main body, which stores at least image data.

2. The image forming apparatus of claim 1, wherein the information storing device comprises a disk-shaped storing medium.

3. The image forming apparatus of claim 1, further comprising an automatic document feeder which is disposed on a top surface of the main body.

4. The image forming apparatus of claim 3, wherein the recording sheet storing section is capable of being drawn frontward from the main body, and the information storing device is disposed on a rear side of the automatic document feeder.

5. The image forming apparatus of claim 4, wherein the information storing device comprises a disk-shaped storing medium, and is disposed so that an information storing surface of the disk-shaped storing medium is parallel to a rear surface of the main body.

6. The image forming apparatus of claim 4, wherein the automatic document feeder is disposed to be protruded from the main body, and the information storing device is disposed to be protruded from the main body.

7. The image forming apparatus of claim 1, further comprising a housing in which the information storing device is housed, wherein the housing is protruded upward from the main body, and comprises a part capable of being opened or closed.

8. The image forming apparatus of claim 7, wherein the housing has a draft hole.

9. The image forming apparatus of claim 7, wherein a width in a left and right direction of the housing when viewed from the front side of the main body is smaller than a width in the left and right direction of the main body when viewed from the front side of the main body.

10. The image forming apparatus of claim 1, wherein the recording sheet storing section is composed of a plurality of sheet feeding trays arranged in a vertical direction, and a sheet feeding tray having a largest capacity of sheets is disposed in a lowermost position of the trays.
